(19) United States
(12) Patent Application Publication
(10) Pub. No.: US 2008/0300977 A1
(43) Pub. Date: Dec. 4, 2008

(54) Method and System for Fractionally Allocating Transactions to Marketing Events

(75) Inventors: Lee P. Gerakos, Erie, CO (US); Jonathon M. Goade, Chicago, IL (US)

Correspondence Address: AKIN GUMP STRAUSS HAUER & FELD LLP, 1111 Louisiana Street, 44th Floor, Houston, TX, 77002, US

(73) Assignee: ADS ALLIANCE DATA SYSTEMS, INC., Dallas, TX (US)

(21) Appl. No.: 11/756,511

(22) Filed: May 31, 2007

(51) Int. Cl. G06Q 30/00

(52) U.S. Cl. 705/14

(57) ABSTRACT

A fractional response allocation system is designed to accurately measure the effectiveness of marketing campaigns and programs. It determines the impact of each marketing event that has influenced a customer's purchase by allocating some amount of credit towards the customer purchase for each of the existing open marketing campaigns present during the customer's purchase window. The system factors the recency of the campaign, the mechanism through which the campaign was promoted, the relationship between products promoted and products purchased into the amount of credit any sign campaign is given towards a single customer purchase. Other factors unique to a given industry and/or business can be taken into account when assigning credit to any given promotion.

### CROSS-REFERENCE TO RELATED APPLICATIONS

N/A

### STATEMENTS REGARDING FEDERALLY SPONSORED RESEARCH OR DEVELOPMENT

N/A

### REFERENCE TO A MICROFICHE APPENDIX

N/A

### BACKGROUND OF THE INVENTION

1. Field of the Invention

The present invention relates to the field of transaction allocation and in particular to systems for allocating transactions among multiple marketing events.

2. Description of the Related Art

In today's complex multi-media, multi-channel world, marketers continue to struggle with understanding how to best optimize their marketing budgets. With tighter constraints on marketing and advertising budgets, companies need a more integrated approach to optimizing their overall marketing expenditures. A new method for analyzing the effectiveness of promotions, both direct and mass, is needed to help marketers make better decisions of how to attract and retain profitable customers.

Traditionally, direct marketing has had an advantage over mass media in terms of measurability of results. A company could send out a piece of mail with a source or key code printed on it, capture the source or key code when the transaction is made and draw a direct correlation to show that a given promotion drove a given transaction. The measurement of mass media has made drawing this direct correlation between promotions and transactions more difficult, involving more inferential methods, such as taking a baseline of sales in a given area prior to running a promotion or using market research/survey techniques to gauge the effectiveness of a given promotion.

The direct marketing method of measuring promotional effectiveness is not without flaw, especially in light of the explosion of both promotion and response channels. With the introduction of the Internet as both a promotion (e.g. banner advertising, email, search engines, etc.) and response channel (online stores and payment capabilities), marketers found it more difficult to measure the true impact of direct promotions. For example, a consumer may receive a catalog, log onto Google, type the sending company's name in as a search, click on a paid search link, and place an order without any source code or key code. In the present example, the Google paid search might get all of the credit for driving the transaction, but the true “path to purchase” should have also included the mailed catalog as a driver of the transaction.

In the past, direct marketers have used a technique call a “matchback” to help resolve some of the channel “noise” described above. For example, if a transaction (purchase) is completed without a source code or key code, the identifiable customer information on the transaction (typically name and address) can be matched to promotion (advertising or marketing) history data (which also contains name and address) and an inference can be made that the promotion drove the transaction. However, matchbacks have certain inherent flaws. For example, matchbacks typically give full credit to a single promotion for driving a transaction and ignore the other promotion media that might have had an impact in the transaction or sale. While this technique helps optimize what customers or prospects a company should select for direct mail promotion, it does little to facilitate the understanding of the overall impact of other promotional media both direct (e.g., email) and mass (e.g., radio or television) on a consumer's behavior.

### BRIEF SUMMARY OF THE INVENTION

A fractional response allocation program allows optimizing a promoter's marketing mix. Fractional response allocation combines data surrounding a given transaction and, based on a set of customizable business rules, gives credit to the multiple promotions that drove it.

Various embodiments use transaction and effort data to attempt to accurately measure the effectiveness of marketing campaigns and programs. The impact of each marketing event that has influenced a customer's purchase is determined by allocating some amount of credit towards the customer's purchase to existing open marketing campaigns present during the customer's purchase window. Factors such as the recency of the campaign, the mechanism through which the campaign was promoted, and the relationship between products promoted and products purchased can be considered when determining the amount of credit any single campaign is given towards a single customer purchase. Other factors unique to a given industry and/or business can be considered that the user desires to take into account when assigning credit to any given promotion.

### BRIEF DESCRIPTION OF THE SEVERAL VIEWS OF THE DRAWINGS

A better understanding of the present invention can be obtained when the following detailed description of the disclosed embodiments is considered in conjunction with the following drawings, in which:

FIG. 1 illustrates a flow chart of one embodiment of the factional response allocation system;

FIG. 2 illustrates the evaluation of transaction item/effort data via rules according to one embodiment of the fractional response allocation system;

FIG. 3 illustrates the evaluation of transaction item/effort data via the order curve rule according to one embodiment of the fractional response allocation system;

FIG. 4 illustrates the evaluation of transaction item/effort data via the referral recency rule according to one embodiment of the fractional response allocation system;

FIG. 5 illustrates a user interface for creating a new campaign according to one embodiment of the fractional response allocation system;

FIG. 6 illustrates a user interface for creating a new effort within a campaign according to one embodiment of the fractional response allocation system; and

FIG. 7 illustrates a popup from the user interface for creating multiple treatment versions according to one embodiment of the fractional response allocation system.

### DETAILED DESCRIPTION OF THE INVENTION

Marketers want to accurately measure the effectiveness of marketing campaigns and programs. To do so, they would like to determine the impact of each marketing event that has influenced a customer's purchase. Each of the existing open marketing campaigns present during the customer's purchase window should be allocated some amount of credit towards the customer purchase. However, not all marketing events should receive the same amount of credit. Factors such as the recency of the campaign, the mechanism through which the campaign was promoted, and the relationship between products promoted and products purchased all factor into the amount of credit any single campaign should be given towards a single customer purchase. In addition, it may be desirable to include other factors unique to a given industry and/or business that may need to be taken into account when assigning credit to any given promotion.

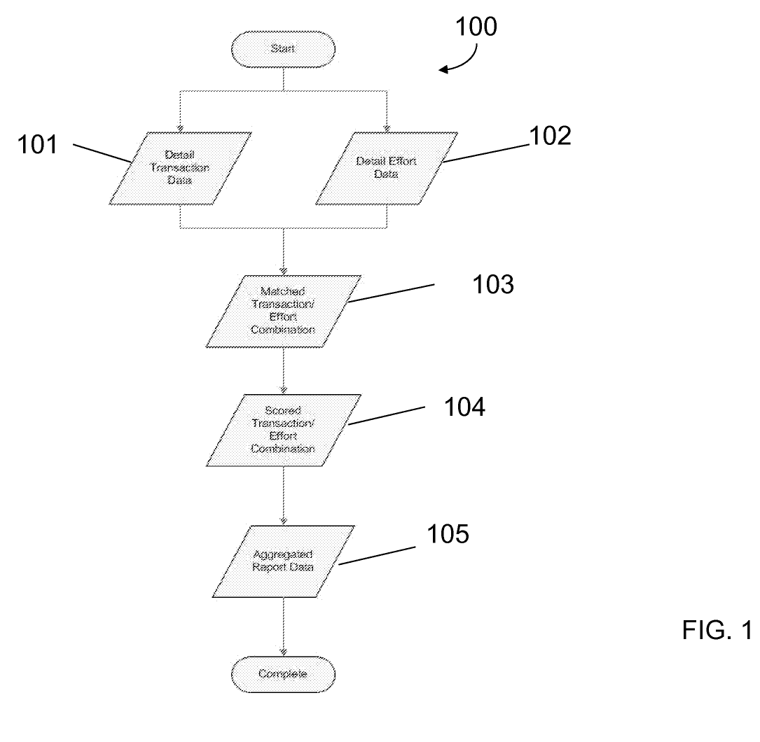

A fractional response allocation system is disclosed herein and combines all the data surrounding a given transaction (typically, a purchase of an item from a marketer), and based on a set of customizable business rules, gives credit to the multiple promotions that drove it. FIG. 1 illustrates a flow chart of one embodiment of the fractional response allocation system 100. Starting with transaction data 101 and effort data 102, one or more database queries associates unmatched transaction, effort, and promotion history combinations for potential matching to create matched transaction item/effort combinations 103. These matched combinations 103 are evaluated by a set of rules to create scored transaction item/effort combinations 104. Finally, the scored transaction item/effort combinations 104 are processed and combined into aggregated report data 105.

Such data may be stored in data arrays and other data structures. Additionally, such data may be stored as data objects in an object oriented database, such as one provided by Oracle.RTM., and/or in a Structured Query Language format. These and/or other data structures may also be utilized throughout the various embodiments of the present invention. Further, in an Internet or other networked embodiment, data can be obtained from a variety of local and/or remote sources and various third party processes and/or systems may be utilized, as necessary, to convert and utilize such data in accordance with particular needs.

An effort is an action a marketer takes to increase demand, and in some embodiments can be in the form of direct, email, retail, search, or affiliate. A direct effort is the sending of a catalog or other direct mail piece to a list of customers and/or prospects. An email effort is the sending of an email message to a list of customers and/or prospects. A retail effort is the existence of retail stores to draw in customers in specific geographic locations. A search effort is the use of search terms to present potential customers with results directing traffic to the marketer's website. An affiliate effort is the use of advertising on affiliate sites to draw potential customers to the marketer's website. A mass effort is the targeting of a particular group based on high level targeting information, such as a geographic location (e.g., Nielsen County or a zip code) or demographic profile (e.g., males age 18-35). These effort types are illustrative and exemplary only and other types of efforts can be used.

In one embodiment, the query associating unmatched transaction, effort, and promotion history combinations takes at least the following information into account when filtering the data: (i) the transaction date falls between the start and end date of the effort, (ii) the last modified time (timestamp of last database update) of the effort or the transaction is later than the last run of the allocation engine, (iii) for efforts with promotion history (such as direct or email), the transaction contains a source keycode that can be located directly in the campaign effort definition or the transaction household/email identifier can be located in the effort's corresponding promotion history. The query can also be customized on a client-by-client basis when additional factors are used to filter in or out potential matches.

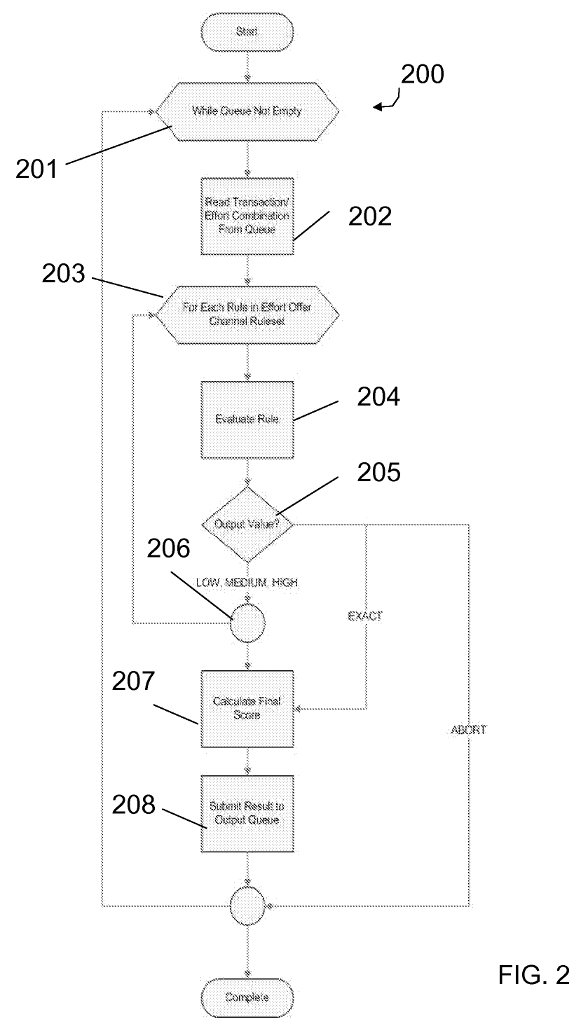

After unmatched transaction, effort, and promotion history combinations are associated via one or more queries, the potential matches are then evaluated within the RuleSets by an allocation engine. FIG. 2 illustrates the RuleSet evaluation 200 of one embodiment of the present invention. Each offer channel will be configured with a discrete set of rules, collectively known as a RuleSet, that will be applied to transaction item/effort combinations based on the effort's offer channel. An offer channel is the outbound mechanism through which a customer and/or prospect is contacted, e.g., direct, email, search, affiliate, and alternate (catchall offer channel). The list of channels is exemplary and illustrative only and other channels can be used. The RuleSet evaluation 200 begins by determining if the queue is empty in block 201. If the queue is not empty the RuleSet evaluation 200 reads the transaction item/effort combination from queue in block 202. Block 203 takes each rule in the offer channel RuleSet sequentially, and evaluates the rule in block 204. The output value will be a degree of confidence that a specific rule has in its match. Next, the output value will be assigned the label “LOW,” “MEDIUM,” “HIGH,” “EXACT,” or “ABORT.” The labels “LOW,” “MEDIUM,” “HIGH,” “EXACT,” AND “ABORT” are illustrative and exemplary only, and other labels and numbers of labels can be used. Whether to assign a label to a given output value can be customizable by the user. For example, one user might wish to label anything above 75% confidence as “HIGH,” while another user may wish to label anything above 65% confidence as “HIGH.” After the rule is evaluated, the output value is evaluated in block 205.

If the output value is “LOW,” “MEDIUM,” or “HIGH,” block 206 causes block 203 to be repeated for the next rule in succession. However, if the output value is “EXACT,” the analysis is finished and the program has determined which effort led to the transaction. If the output value is “ABORT,” the logic loop will be exited and subsequent rules will not be evaluated. “ABORT” is used as an exit strategy and the effort in the transaction item/effort pair will not receive any allocation or credit for the customer's purchase.

Each rule is assigned a weight within the RuleSet which is used to specify the overall influence a single rule has within the set of rules. The confidence factor for matching a transaction item/effort pair is calculated using the following equation, which weighs the result of each rule evaluation:

$$CONFIDENCE FACTOR = \frac{{\sum }_{i = 1}^{Num rules} {rule}_{i} ( txn , effort ) \times {Weight}_{i}}{{\sum }_{i = 1}^{Num rules} {Weight}_{i}}$$

When each rule is evaluated, the next step is to calculate a final score, or match value, in block 207. The final score is calculated using a boost percent and an offer channel weight. The boost percent is the maximum increase of the confidence factor that a rule can be given. The closer the transaction is to the beginning of the start date of the effort, the greater the boost percent. Boost percent is calculated using the following equation:

$$BOOST PERCENT = ( \frac{Total Days - Num Days}{Total Days} ) \times Total Boost$$

### Where:

Total Days=the total number of days the effort is open;

Num Days=the number of days between the start date of the effort and the transaction date; and

Total Boost=the total potential boost percentage available for a given offer channel.

The final confidence factor is calculated by adding the boost percent to the confidence factor:

Final Confidence Factor=Confidence Factor+Boost Percent

After determining the final confidence factor corresponding to a given rule, the channel weight is used to allow for a controlled allocation of demand across multiple offer channels. Channel weights allow differentiating the importance of different offer channels. For example, a $100 transaction may match to one (1) direct effort and one (1) email effort at a 30% confidence level each. Since the confidence levels are equal, if the direct effort has a channel weight of 100, then both receive a 50% allocation. If the channel weight for the direct effort is increased to 200, then the direct effort receives a 67% allocation.

The offer channel weight can be modified as desired, including time dependent weighting. For example, during the last week of the holiday season, more weight can be given to the retail offer channel. The following calculation is used to compute the total points earned by a given transaction item/effort pair:

Match Value(txnᵢ, effortⱼ)=Final Confidence Factor(txnᵢ, effortⱼ)×Channel Weight

To determine the fractional allocation for a given effort, the following calculation is used:

$$Fractional Allocation ( {txn}_{i} , {effort}_{j} ) = \frac{Match Value ( {txn}_{i} , {effort}_{j} )}{{\sum }_{l = 1}^{Num efforts matched} Match Value ( {txn}_{i} , {effort}_{l} ) }$$

The fractional allocation is used to allocate dollars, or any other metric, including items and orders, associated with the transaction to each effort in the campaign. For example, if the amount of value for a given transaction is $100, and a direct effort generated a fractional value for the transaction of 0.3, while an email effort generated a fractional value for the transaction of 0.7, then the direct effort would be allocated $30 of the transaction and the email effort allocated $70.

In at least one embodiment of the present invention, the RuleSet can include one or more standard rules. The allocation engine can also be customized to contain client-specific rules. In some embodiments, some standard rules can be used only for a subset of the available order channels. When the RuleSet generates output values that are labels for confidence value ranges, as described below, the labels can be assigned numerical confidence values. For example, a output value of LOW can be assigned a 0.1 confidence value, indicating 10% confidence, an output value of MEDIUM can be assigned a 0.5 confidence value, indicating 50% confidence, an output value of HIGH can be assigned a 0.95 confidence value, indicating 95% confidence, and an output value of EXACT can be assigned a confidence value of 1, indicating 100% confidence in the result. An EXACT match can ignore factional allocation or optionally be divided among the other matching efforts. In some embodiments, an output value of ABORT is not assigned a confidence value, but causes an exit condition. In other embodiments, the RuleSets generate numerical output values instead of labels. In the following, the labels of LOW, MEDIUM, HIGH, EXACT, and ABORT and the confidence values associated with those labels are exemplary and illustrative only, and other labels, values, and numbers of labels can be used. In some embodiments, the user can configure which labels are used. Each standard rule can be customizable with parameters to configure the operation of the standard rule.

Rules in the RuleSet can consider a wide variety of factors when evaluating the fractional allocation. Some factors that can be considered are: the recency of the campaign, the mechanism through which the campaign was promoted, the relationship between products promoted and products purchased, and the demographic profile of the customer. For example, if a radio ad was targeted at males 18-35 in a given zip code and a transaction comes in from a customer with a matching demographic profile, some portion of the transaction can be allocated to the mass radio campaign. Other factors unique to a given industry and/or business can be used. For example, retail customers might want to integrate retail area information into the matching, since having a retail store in a customer's area has a promotional effect onto itself. These factors are exemplary and illustrative only, and any other factors that the user desires to take into account when assigning credit for a promotion can be used.

Rules may be altered or configured in numerous ways. For example, a rule may use simple parameters such as what output value should be provided if no match is found. Other, more complex configurations or alterations can be provided. In one embodiment, responders may be categorized into clusters, and rules or weights may be configured based on those clusters. For example, if certain types of buyers tend to respond better to email than to direct campaigns, for those buyers, the email channel can be weighted higher than direct campaigns. For other groups of buyers that respond more to catalog promotions, the weighting can be reversed.

For example, one of the standard rules in some embodiments is a Keycode rule. This rule determines if the Keycode listed on the transaction matches the Keycode used when marketing to the responder or purchaser.

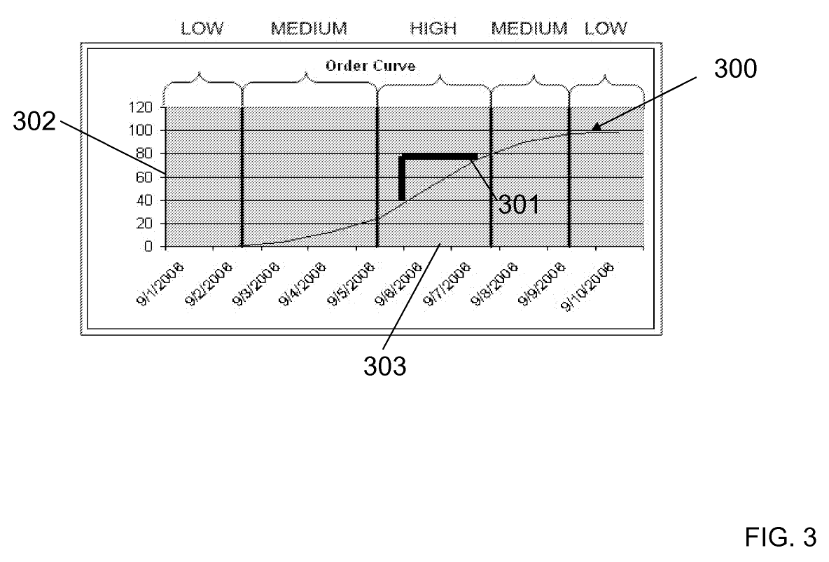

Another one of the standard rules can be an Order Curve Rule. This rule takes into account the slope of the order curve in the effort during the time the transaction was made. When the slope of the order curve is lower, less value is given to the effort, whereas more value is given to the effort during periods where the slope is high. This rule is effective in some embodiments only for direct and email efforts. FIG. 3 illustrates how the Order Curve Rule operates. The order curve is obtained from a graph of the number of orders 302 versus the number of days the effort has been in effect 303. The rule generates a larger confidence factor for the match when the slope 301 of the order curve 300 is larger. Additionally, the output value can be assigned a label, e.g., “HIGH,” “MEDIUM,” or “LOW” based on the value of the slope.

A SKU rule is another exemplary standard rule. The SKU rule determines if the transaction item purchased was listed in the effort. If the transaction item purchased was listed in the effort treatment, a match is made, otherwise, no match is made. In some embodiments, this rule is available only for direct and email offer channels. This rule provides either a “HIGH,” “MEDIUM,” or “LOW” value depending on whether the SKU on the transaction item matches a SKU in the effort. For example, the output value may be “HIGH” when the SKU on the transaction item matches a SKU in the effort. If the SKU on the item does not match any SKU in the effort, the output value may be “LOW.”

The Email Action rule is another exemplary standard rule. This rule evaluates the action taken by the responder to see if the email promotion was actually viewed. If no action was taken by the responder, the allocation engine can be configured to output a value of ABORT. This rule provides either a “HIGH,” “MEDIUM,” or “LOW” value depending on what action the responder took. For example, if the responder actually clicked on a link within the email, the output value could be “HIGH.” If the responder simply opened the email, the output value could be “MEDIUM.”

Another exemplary standard rule the Effort Offer Channel/Transaction Channel Rule. This rule simply allows for an association between an effort and transaction based solely on channels. For example, if the offer channel and transaction channel are both RETAIL, then this rule could give an output value of “MEDIUM.” The output values for certain combinations can be customized by the user. For example, if the offer was via phone and the transaction was via phone, the user might want the output value to return a “LOW.” In addition, the effort offer channel/transaction channel rule can be used to filter out transactions. For example, the rule can be used to ensure no retail transactions are allocated to an email offer.

The Effort Division/Transaction Channel Rule is another exemplary standard rule. This rule looks at the Effort Division (any specified portion of an effort) and Transaction channel and allow for an association between the two based solely on comparing the promoting effort division and the transaction channel. For example, this rule can be used to prevent any retail transactions from being allocated back to an effort within Division X.

The Order Channel/Keycode Pattern Rule is another exemplary standard rule. This rule looks at the order channel and keycode combination for any given transaction. This rule is used to allow for certain keycode patterns to be omitted or scored for certain order channels. In one embodiment, keycode patterns are represented by regular expressions. For example, this rule could be used to Abort the scoring of any Internet orders with a keycode pattern of “.I.*” (where “.” is “any character” and “*” is 0 or more occurrences of that character), which would be matched by any keycode with an I as the second character. This rule can also be used to assign any orders from a particular channel, for example, Web orders, with a predefined keycode pattern a desired output value, such as “HIGH.” In some embodiments, multiple combinations of order channel, keycode, patterns, and output values can be specified by the rule, with a separate output value defined for when the transaction does not match any of the order channel, keycode, and pattern combinations.

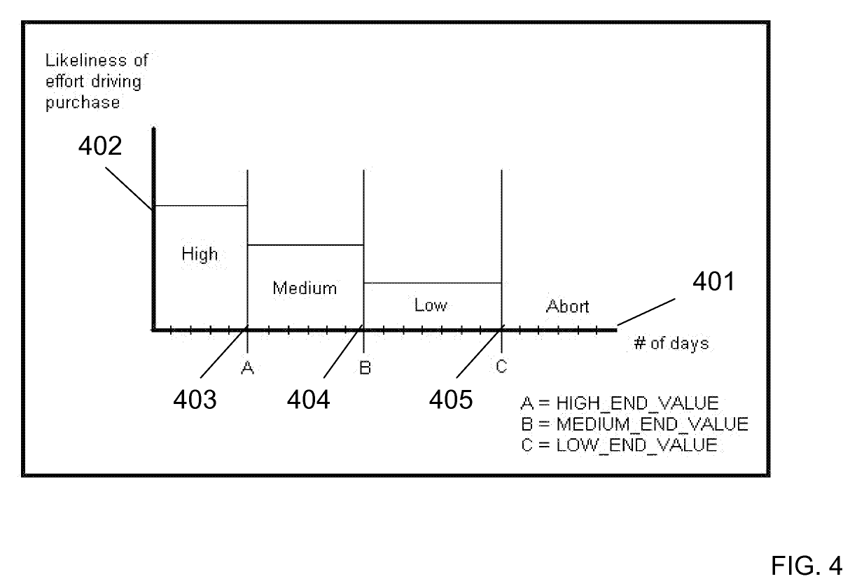

The Referral Recency Rule is another exemplary standard rule. This rule takes into account the likelihood of the offer to have driven the transaction based on the number of days between the referral or offer and the transaction. The closer the transaction is to the referral, the greater the value given to that effort. Depending upon the number of days between the offer and the transaction, an output value can be assigned based upon the user's preferences. Refer to FIG. 4 for a depiction of how this rule works. The x axis 401 displays the number of days since the referral and the y axis 402 displays the likelihood of the referral driving the purchase. These values are customizable by the user. For example, the user can assign an output value of “HIGH” to days 1 through 100, or days 1 through 10. The High End Value 403 is the end value given for the HIGH range of output values. The Medium End Value 404 is the end value for the MEDIUM range and the Low End Value 405 is the end value for the LOW range. For anything greater than the Low End Value, the output value is “ABORT.”

Another exemplary standard rule is the Search Term Rule. This rule can be configured to take a regular expression and output a value. For example, if there is an online marketer that has a site called www.tomsclocks.com that sells clock radios, if a search term of “www.tomsclocks.com” is entered, the output of the Search Term rule could be “LOW”, but if a search term of “clock radios” was entered, the output value could be “HIGH.” In the first example, the customer had already made a decision where to buy the item, but in the latter example, the customer was searching for clock radios and due to the effectiveness of the search term, was driven to the marketer.

Custom rules can also be provided. Because a rule is a pluggable software component, custom rules can be specifically defined for a given client's business. For example, if a client wanted to give no allocation to a certain effort for some reason (maybe the effort was just experimental), a custom rule can be created that would assign an output value of “ABORT” each time the effort was this experimental effort.

In one embodiment, the output value of each transaction item/effort pair is written to a file. There is a separate output file for each effort allocated during the allocation engine's execution. In some embodiments, the output file contains the following information:
Company Code
Effort ID
Transaction ID
Transaction Item ID
Match ID
Number of Days Effort is Open
Number of Days into Effort Transaction is made
Keycode on Transaction
Keycode on Matched Effort
Date Match Occurred

This information contained in the output file is illustrative and exemplary only and other output values and number of output values can be used.

Subsequent to all of the data being written to individual output files, the data will then be loaded into a database. Each output file can be loaded into a separate partition within the database for performance reasons, if desired. Once all of the data is loaded into the database, it can be aggregated into separate structures that are designed for reporting purposes. Alternatively, the output values can be loaded into the database as they are created, without writing to a separate output file.

In one embodiment, several standard rollups or data reporting variables are included. The standard rollups will can include:
Fractional Dollars by Transaction item/effort Combination
Fractional Dollars summed to Keycode within Effort
Fractional Dollars summed to Effort
Fractional Dollars summed to Division
Fractional Dollars summed to Channel
Fractional Dollars summed to Campaign

The rollup process aggregates the data for reporting purposes. For example, the Fractional Dollars by Transaction item/effort Combination takes the assigned confidence factor, boost percentage, and match value to calculate the fractional dollars associated with the transaction item, as described above. These standard rollups can serve as the foundation for additional rollups.

These standard rollups are illustrative and exemplary only and other rollups and number of standard rollups can be used. In addition to these standard rollups, the program is customizable to any specific client's needs. For example, the client may want to determine the relationship between the fractional dollars per effort and the number of days each effort was in effect.

A user interface can display the rollups and other output values that the user would like to see displayed. The user interface can be any type of those known in the field and can be customizable to the client's needs. Preferably, the user can choose to see data in graph or table form and which output values are displayed. In some embodiments, standard tables and/or graphs are provided for the user to choose from. In the following descriptions, the layout and content, number, and type of fields on the user interface screens of the user interface are exemplary and illustrative only, and other layouts and content, number, and type of fields can be used.

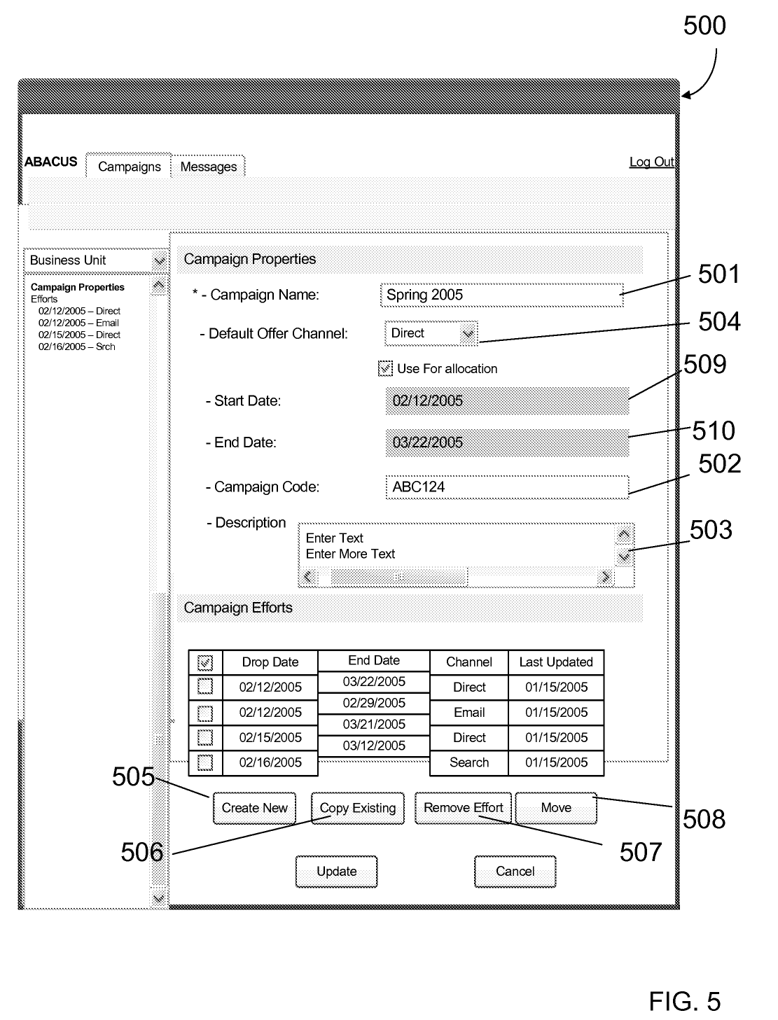

In one embodiment, the user interface also can be used to enter the necessary information so that the allocation engine can associate a single transaction (or transaction item) to multiple marketing efforts. For example, the user interface can be used to enter the information to create a new campaign (a group of marketing efforts). FIG. 5 illustrates one embodiment of a user interface screen 500 for creating a new campaign. The user can enter a name into the Campaign Name field 501, a code into the Campaign Code field 502, and a description into the Description field 503. Additionally, the user can choose from a list of Default Offer Channels 504. This is the offer channel that will be the default for all newly created efforts in that campaign. As shown in FIG. 5, the Start Date and End Date fields, 509 and 510, are read only fields that are derived from the earliest start dates and latest end dates of efforts within the campaign. In other embodiments, start date and end date values can be entered. The user is also given the choice of whether to create a new effort, copy an existing effort, remove an effort, or move an effort. The user can chose any of those actions by using the corresponding buttons 505-508 at the bottom of the form.

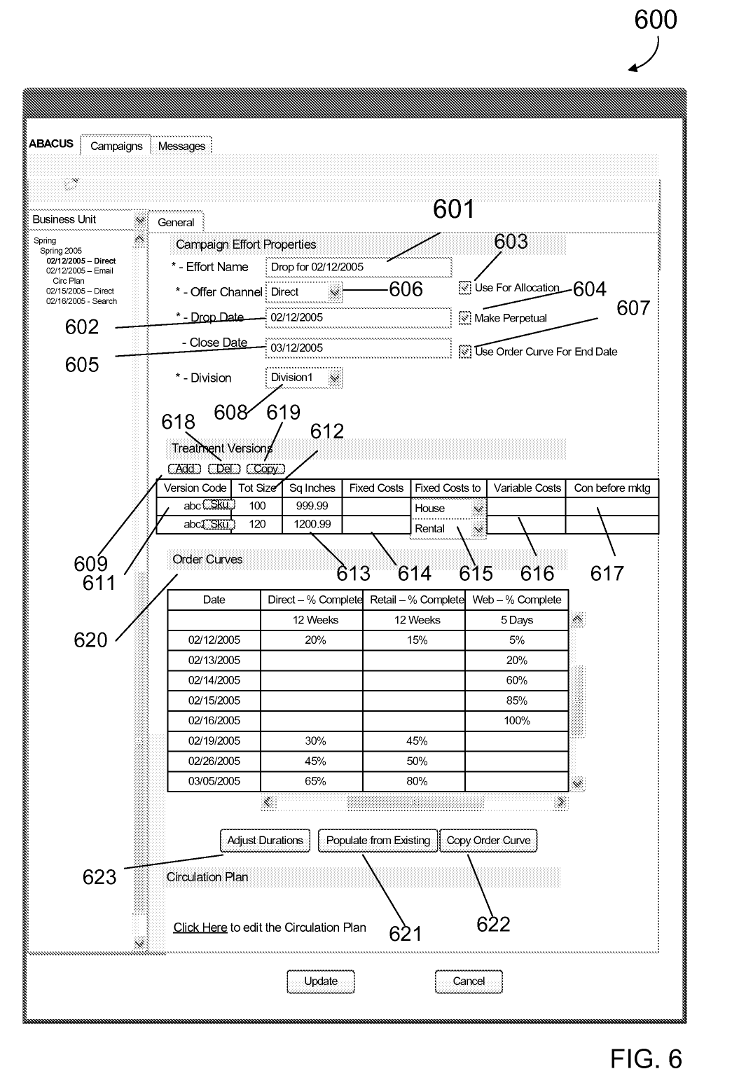

The user interface can also be used to enter the information to create a new campaign effort. FIG. 6 illustrates a user interface screen 600 according to one embodiment, for creating a new effort within a campaign. The user can enter an effort name into the Effort Name field 601. The user can also enter a drop date into the appropriate field 602. This field defaults to today's date. The “Use for Allocation” flag 603 defaults to checked and makes the effort available for transactions to be attributed to it. This flag 603 is useful for efforts to which demand should not be attributed. The Make Perpetual Flag 604 keeps the effort open for attributing transactions to it. This is especially useful for Search and Affiliate Efforts. The Close Date 605 can be entered for certain offer channels. The user can also enter the Offer Channel 606. If the default offer channel 504 is set on the Campaign, then the Offer Channel 606 by default is set to the default value for the Campaign. The “Use Order Curve for End Date” flag 607 determines if the end date is calculated using the Order Curve or the Close Date. The user can also specify a Division 608 only if there is more than one division specified for the client.

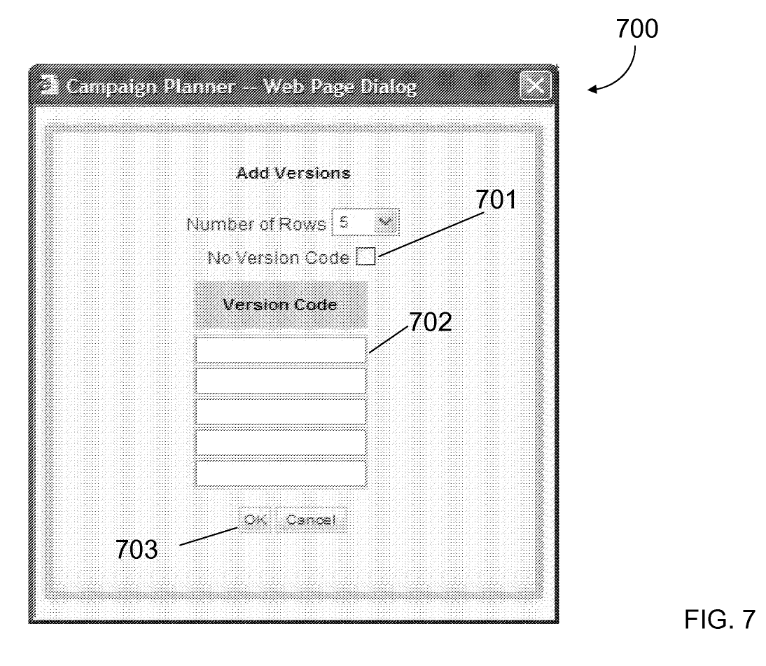

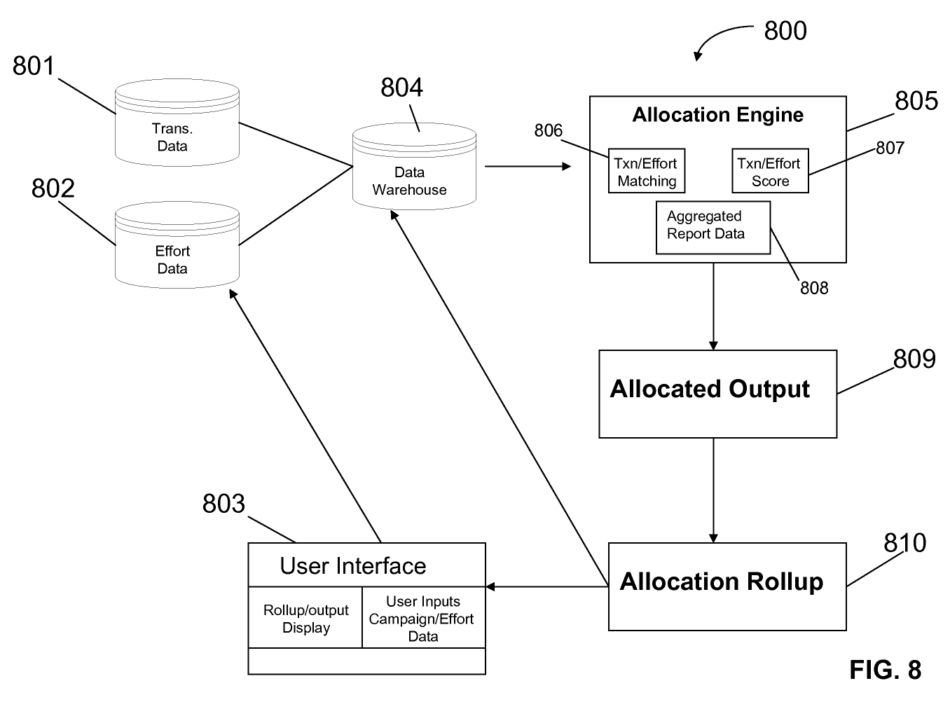

In order to add a treatment version (used to associate costs to an effort) in one embodiment, the user can click the Add button 609 at the top of the Treatment Version section of the effort screen 600. A popup 700 (FIG. 7) is then displayed, allowing the user to create up to 100 or any other predetermined maximum number of treatment versions at a time. The No Version Code field 701 allows the user to create Treatment Versions without specifying a Version Code 702. Once the user has added all of the treatment versions needed, the user can press the OK button 703 and is taken back to the effort screen 600. Other techniques for entering Treatment Version information can be used. The user can then enter the SKU data 611, the Total Size 612, the Total Square Inches 613 and the Fixed Costs 614. Preferably, the user can then select whether to allocate fixed costs to House, Rental, or Both 615. House allocates fixed costs to current customers and Rental allocates fixed costs to prospects. In some embodiments, the user can also enter variable costs 616 and contribution costs 617. Finally, the user can either delete or copy the treatment versions by using the DELETE 618 and COPY 619 buttons.

By default, an order curve 620 can be populated for the user. The default duration for each order curve differs by offer channel as illustrated in Table 1 below:

TABLE 1

| Offer Channel | Duration | |
|---|---|---|
| Direct | 12 | weeks |
| Alternate Source | 12 | weeks |
| Email | 5 | days |

These values are exemplary and illustrative only and other default durations can be used. Also by default, each entry in the order curve is evenly divided throughout the order curve duration. The user can specify the order curve duration or use the default system supplied values. The user can also adjust durations within the order curves by simply using the Adjust Durations button 623. In some embodiments, the user is able to replace the default order curve by either copying an order curve from a predefined campaign or copying an order curve based on the actual order curve from a closed campaign by using buttons 621 and 622.

The effort's end date can be calculated using the following logic:

(1) If the perpetual flag 604 has been set to true, then the end date is: Dec. 31, 9999 and the User Interface displays this as “Perpetual.”

(2) Else if the currently selected offer channel allows the close date filed to be shown and the user has entered a value and the “Use Order Curve for End Date” field is not checked, then the end date is the close date.

(3) Else if the currently selected offer channel allows the order curve to be shown, then the end date is the last order curve date.

This logic is illustrative and exemplary only and other logic can be used to calculate the effort's end date.

The following Table 2 is a demonstrative example of allocation pursuant to one embodiment, where the RuleSet is for a Direct Offer Channel:

TABLE 2

| Rules* | |
|---|---|
| Keycode Rule | Weight: 600 |
| Order Curve Rule | Weight: 400 |
| SKU Rule | Weight: 200 |
| Rule Output Value Factors** | |
| HIGH | 75% confidence in match |
| MEDIUM | 50% confidence in match |
| LOW | 25% confidence in match |
| Max Recency Boost Percentage | |
| Direct Offer Channel | 5% |
| Email Offer Channel | 2% |
| Offer Channel Weight | |
| Direct | 2000 |
| Email | 1000 |
| Effort Data | |
| Start Date | Feb. 02, 2006 |
| End Date | Feb. 25, 2006 |
| Offer Channel | Direct |
| Transaction Data | |
| Transaction Channel | Web |
| Transaction Date | Feb. 9, 2006 |
| Dollar Amount | $100.00 |

When matching a single effort using a direct offer channel to a transaction, the following exemplary Table 3 illustrates outcomes and values produced after evaluating the above RuleSet:

TABLE 3

| | | Output | Corresponding | |
|---|---|---|---|---|
| Rule | Weight | Value | Factors | Weighted Score |
| Keycode | 600 | HIGH | 75% | 450 |
| Order Curve | 400 | MEDIUM | 50% | 200 |
| SKU | 200 | HIGH | 75% | 150 |
| Total | 1200 | | | 800 |

Using the above exemplary values, given the Rule Weights and Output Values for the given transaction item/effort matching, the Confidence Factor is 800/1200=67%. Once the Confidence Factor has been calculated, it is then increased based on recency using a boost percent. In this example, with Boost Percent as described above:

$$Boost Percentage ( Direct ) = \frac{( 25 - 9 )}{25} \times 0.05 = .032$$

therefore a 3.2% boost is given to the overall confidence factor, producing a confidence factor of 70%. In this example, using the match value equation given above,

Match Value(Direct)=70%×2000=1400.

If there is an additional match for an Email Effort with a final confidence factor of 80%, the final Match Value is 0.80×1000=800.

To determine the fractional allocation for a given rule, the calculation given above is used, producing in this example:

$$FractionalAllocation ( Direct ) = \frac{1400}{2200} = 64 \%$$

$$FractionalAllocation ( Email ) = \frac{800}{2200} = 36 \%$$

To fractionalize the total dollars ($100), one embodiment takes the total number of points from the Direct Effort Match (1400) and the Email Effort Match (800) and uses the following computation:

$$\begin{matrix}Direct Effort Fraction = \frac{1400}{2200} \times \$100 \\ = 64 \% \times \$100 \\ = \$64 allocated demand\end{matrix}$$

$$\begin{matrix}Email Effort Fraction = \frac{800}{2200} \times \$100 \\ = 36 \% \times \$100 \\ = \$36 allocated demand\end{matrix}$$

Once a fractional dollars value (or other fractional metric value) is calculated for each transaction item/effort combination, the system can calculate several other values. For example, if the metric is dollars, the system can use the fractional dollars to calculate fractional dollars summed to keycode within an effort, fractional dollars summed to effort, fractional dollars summed to division, fractional dollars summed to channel, fractional dollars summed by channel to customer, and fractional dollars summed to campaign, or any other desired manipulation of the original fractional alloctaion. Which rollups are displayed and how they are displayed are customizable on a client-by-client basis and are even customizable by the user. In some embodiments, there can be several standard rollups and displays as well. The process can be run once per day or however often a given client would like to see transaction allocation results.

FIG. 8 illustrates an embodiment of a computer system that performs the technique described above. The transaction data 801 and effort data 802 are compiled from various sources, including but not limited to, the user via the user interface 803. Campaign and effort data 802 can be entered by the user via the user interface as described above. Next, the transaction data 801 and effort data 802 can be loaded into and stored in a database or data warehouse 804. From the data warehouse 804 the transaction data 801 and 802 effort data are loaded into the allocation engine 805 so that transactions and efforts can be matched and scored as discussed above. The allocation engine 805 also creates aggregated report data 808 which can be output from the allocation engine 805. After the report data is output from the allocation engine 805, the data is manipulated to create allocation rollups 810 as discussed above. These rollups are then sent to the data warehouse 804 and displayed to the user through the user interface 803 as also discussed above. This computer system is illustrative and exemplary only and other computer systems may be used to complete the fractional response allocation.

The foregoing disclosure and description of the invention are illustrative and explanatory thereof, and various changes in the details of the illustrated technique and system may be made without departing from the spirit of the invention.

We claim:

1. A method, comprising:
creating a ruleset corresponding to an offer channel of an effort associated with a marketing campaign, the ruleset comprising at least one business rule;
generating an effort score by applying the ruleset to a transaction selected from a database of transactions;
weighting the effort score; and
fractionally allocating the transaction to the effort based on the weighted effort score.

2. The method of claim 1, generating an effort score by applying the ruleset to a transaction selected from a database of transactions comprising:
evaluating at least some of the business rules of the ruleset;
generating an output value for each of the evaluated business rules;
assigning a weight value to each business rule;
combining the output values and weight values to generate the confidence factor; and
generating the effort score by modifying the confidence factor.

3. The method of claim 2, evaluating at least some of the business rules of the ruleset comprising:
evaluating each business rule sequentially;
if the output value corresponding to the evaluated business rule satisfies a first predetermined criterion, stopping the evaluation of business rules and indicating the effort generated the transaction; and
if the output value corresponding to the evaluated business rule satisfies a second predetermined criterion, stopping the evaluation of business rules and indicating the effort did not generate the transaction.

4. The method of claim 2, generating the effort score by modifying the confidence factor comprising:
increasing the confidence value corresponding to how close in time the transaction occurred to a start of the effort.

5. The method of claim 2, generating the effort score by modifying the confidence factor comprising:
predefining a maximum modification for the confidence factor.

6. The method of claim 2, generating the effort score by modifying the confidence factor comprising:
defining a length of the effort;
assigning a total boost percentage for the effort;
determining a percentage of effort length occurring prior to the transaction;
generating a boost percentage by multiplying the percentage of effort length occurring prior to the transaction by the total boost percentage; and
adding the boost percentage to the confidence factor.

7. The method of claim 1, weighting the effort score comprising:
assigning a channel weight to the effort; and
modifying the effort score by the channel weight.

8. The method of claim 7, modifying the effort score by the channel weight comprising:
multiplying the effort score by the channel weight.

9. The method of claim 1, fractionally allocating the transaction to the effort based on the weighted effort score comprising:
dividing the effort score by the sum of all other effort scores corresponding to the transaction for the marketing campaign.

10. The method of claim 1, creating a ruleset comprising:
providing at least one standard business rule for the ruleset;
creating a custom business rule for the ruleset responsive to user input; and
customizing the standard business rule responsive to user input.

11. The method of claim 10, wherein the standard business rule determines whether a first keycode associated with the transaction matches a second keycode associated with the effort.

11. The method of claim 10, wherein the standard business rule generates an effort score based on a slope of a user-defined order curve.

12. The method of claim 10, wherein the standard business rule determines whether a transaction item was offered in the effort.

13. The method of claim 10, wherein the standard business rule generates an effort score responsive to whether a responder viewed an email promotion.

14. The method of claim 10, wherein the standard business rule generates an effort score responsive to whether the transaction and the effort used the same channel.

15. The method of claim 10, wherein the standard business rule generates an effort score responsive to a comparison of a division of the effort and a channel used by the transaction.

16. The method of claim 10, wherein the standard business rule generates an effort score responsive to a combination of the effort and a keycode.

17. The method of claim 10, wherein the standard business rule generates an effort score responsive to the time between an offer and the transaction.

18. The method of claim 10, wherein the standard business rule generates an effort score responsive to search terms entered by a responder into a search tool.

19. The method of claim 1, further comprising:
displaying rollups of fractional allocations to a user.

20. The method of claim 1, wherein the transaction is an item of a multi-item purchase transaction.

21. The method of claim 1, generating an effort score by applying the ruleset to a transaction selected from a database of transactions comprising:
selecting a transaction by querying a database for potential matches of transactions and efforts.

22. A system, comprising:
a computer system;
a effort database;
an transaction database;
a ruleset database;
an allocation engine software stored on a storage subsystem of the computer system, that when executed causes the computer system to:
select a plurality of rulesets corresponding to a plurality of offer channels of a plurality of efforts associated with a marketing campaign, each of the rulesets comprising at least one business rule;
generate a plurality of effort scores corresponding to each effort of the plurality of efforts matched with the transaction by applying the ruleset corresponding to the effort to a transaction selected from the transaction database;
weight the plurality of effort scores; and
fractionally allocate the transaction to the efforts based on the weighted effort scores.

23. The system of claim 22, further comprising:
a user interface software stored on a storage subsystem of the computer system that when executed causes the computer system to:
allow a user to construct a ruleset of the plurality of rulesets from a combination of standard rules and user-defined rules; and
allow a user to manipulate and display report data output by the allocation engine.

24. The system of claim 22, further comprising:
a data warehouse for storing output data from the allocation engine.

25. A method for associating a single transaction with a plurality of marketing efforts, comprising:
generating a ruleset of business rules for each of the plurality of marketing efforts;
evaluating the business rules of each of the rulesets against a transaction to determine a match value for each effort;
weighting the match value for each effort; and
fractionally crediting each effort for the transaction.

26. The method of claim 25, further comprising:
performing one or more database queries to associate unmatched transaction, effort, and promotion history data.

27. The method of claim 25, further comprising:
displaying the fractional credit given to each effort.

28. The method of claim 25, generating a ruleset comprising:
providing a user interface to an allocation engine;
generating the ruleset responsive to user selections of predefined standard business rules;
customizing the ruleset responsive to user customizations of the predefined standard business rules; and
customizing the ruleset responsive to user rule definitions.
